(19) United States
(12) Patent Application Publication
(10) Pub. No.: US 2009/0281910 A1
(43) Pub. Date: Nov. 12, 2009

(54) PERSONALIZED FRAMED ART SYSTEM

(76) Inventor: Angela D'Amica, Bridgeport, CT (US)

Correspondence Address: VENABLE LLP, P.O. BOX 34385, WASHINGTON, DC, 20043-9998, US

(21) Appl. No.: 12/424,534

(22) Filed: Apr. 15, 2009

Related U.S. Application Data
(60) Provisional application No. 61/044,954, filed on Apr. 15, 2008.

(51) Int. Cl. G06Q 30/00; A47G 1/06

(52) U.S. Cl. 705/26; 40/700

(57) ABSTRACT

A framed art system in which a user may personalize framed art.

### CROSS-REFERENCE TO RELATED APPLICATIONS

This application claims the benefit of the following related application: application Ser. No. 61/044,954 filed on Apr. 15, 2008, the contents of which are incorporated herein by reference in their entirety.

### BACKGROUND OF THE INVENTION

1. Field of the Invention

This invention relates generally to the field of picture frames used for the display of photographs, paintings, and the like, and more particularly to an improved system for providing an individualized, personalized message-containing piece of art as a decorative border.

2. Statement of the Prior Art

In the picture frame art, it is usual to provide a rectangular or other shaped frame having a self-supporting means, a transparent cover sheet of glass or synthetic resinous material, and a planar insert or template which provides the artwork, such as a photograph, drawing, painting or other piece of art.

However, there is a need in the picture frame art for a means to personalize framed art. There is also a need to make available to those who may wish to use such means to order and obtain such personalizable framed art online.

### BRIEF DESCRIPTION OF THE DRAWINGS

Embodiments will now be described in connection with the associated drawings, in which:

FIG. 1 is an exploded view of the personalizable framed art system;

FIG. 2 is a perspective rear view of the frame;

FIG. 3 is a front view of the personalizable framed art system;

FIG. 4 is a front view of the personalizable framed art system, after it has been personalized;

FIG. 5 is a rear view of one embodiment of the personalizable framed art system; and

FIG. 6 is a block diagram illustrating another, website embodiment of the personalizable framed art system according to the present invention.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. The exemplary embodiments so disclosed, however, are not intended to be limited to the specific terminology selected. Persons of ordinary skill in the relevant and related art wills recognize that other components and configurations may be used without departing from the true spirit and scope of the embodiments. It is to be understood that each specific element includes all technical equivalents that operate in a similar manner to accomplish a similar purpose. Therefore, the examples and embodiments described herein are non-limiting examples.

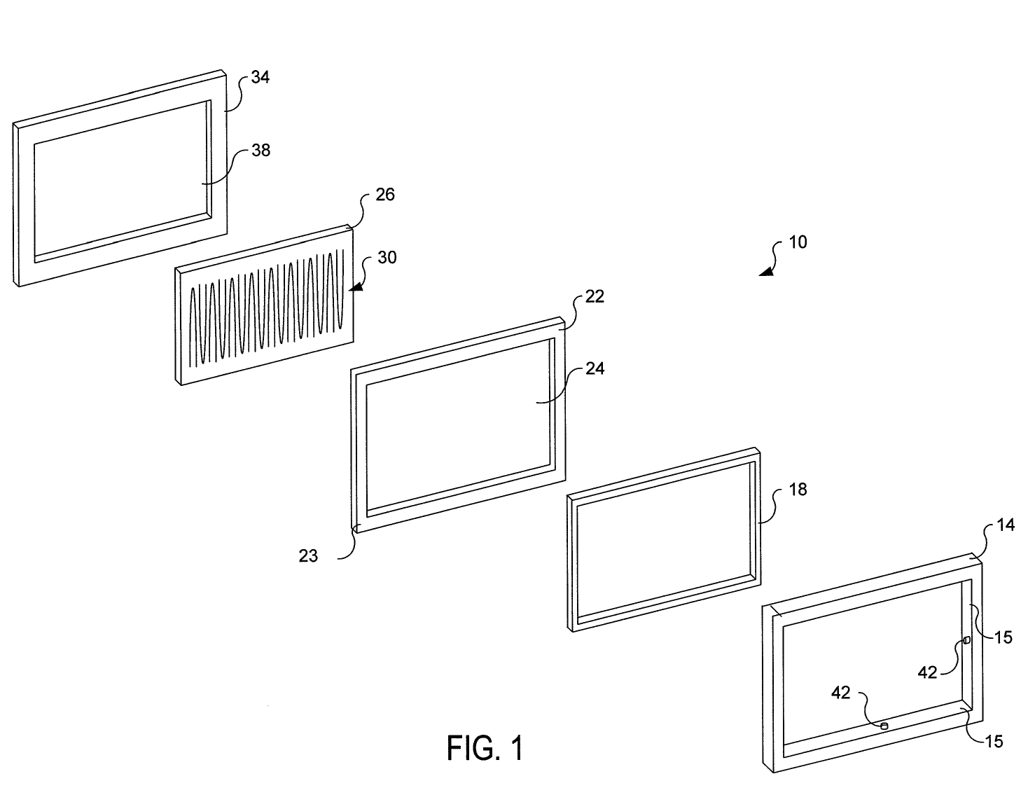

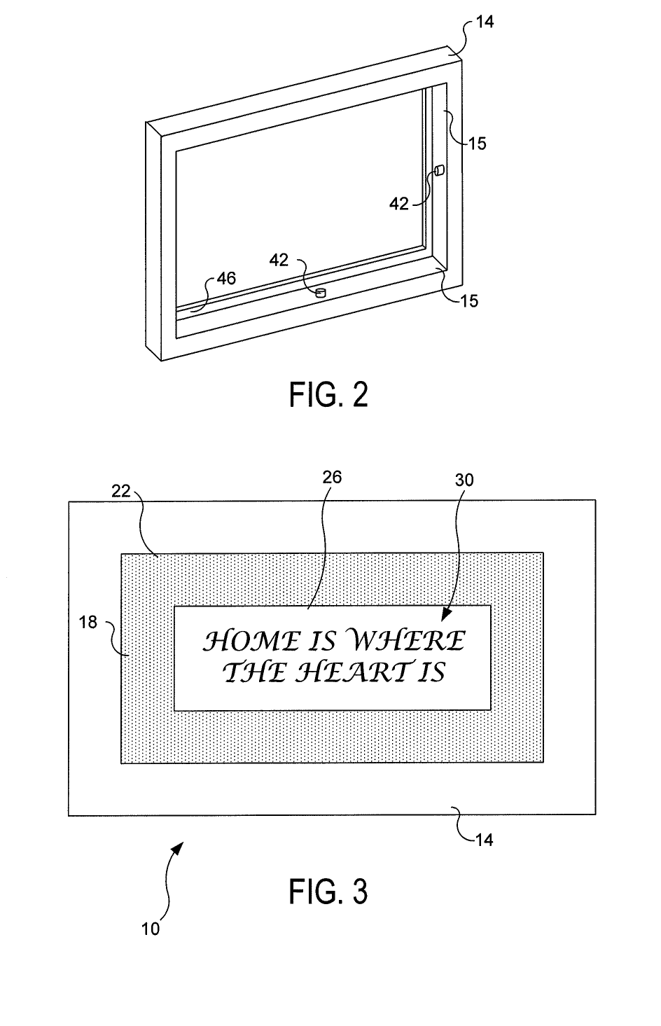

Referring first to FIG. 1 an exploded view of a first embodiment of the personalizable framed art system 10 is shown. The personalizable framed art system 10 comprises a frame 14, a translucent or transparent cover 18 (e.g., glass or plastic), a border 22, and an insert card 26 with content (e.g., text or graphics in the form of a “saying”) 30, and a base card 34. The insert card 26 is configured to sit in an indentation 38 located in base card 34. Note that the indentation is not a hole in the base card 34, but rather is simply an indentation 38 in the base card 34 to show a user where to install the insert card 26. In other embodiments, instead of an indentation, the base card 34 may be scored to show where the insert card should lay. The insert card 26 may be attached to the indentation 38 via a non-permanent adhesive. The non-permanent adhesive may be comprised of a removable pressure-sensitive acrylic adhesive. The adhesive may be similar to the adhesive commonly utilized with POST-IT notes. One such suitable adhesive is commercially available from FLEXcon Company, Inc., 1 FLEXcon Industrial Park, Spencer, Mass. USA 01562-2642, under the product designation of FLEXmark V-314 Adhesive. The specifications for this particular non-permanent adhesive and other suitable alternative adhesives may be found in the “Adhesive Selection Guide” published by FLEXcon, which is incorporated by reference herein. In other embodiments, a permanent adhesive may be used to attach the insert card 26 to the indentation 38. If the insert card 26 is removed from the indentation 38, after being attached with a permanent adhesive, slight damage may be done to the indentation 38 portion of the base card 34 and to the inert card 26, but will not be noticeable when a replacement insert card 26 is applied to the indentation 38 with a permanent or non-permanent adhesive. A border 22 goes between the base card 34 (with the insert card 26 attached to the indentation 38 of the base card 34) and cover 18. The border 22 may have a decorative design on the front surface 23. A hole 24 is located in the border to allow viewers to see the insert card 26 and saying 30. The base card 34, insert card 26, border 22, and cover 18 all fit in the frame 14 and are held in place by a lip 46 on the frame 14 (shown in FIG. 2) and a plurality of bendable tabs 42 located on the inner surface 15 of the frame 14. Alternative means for holding the base card 34, insert card 26, border 22, and cover 18 may comprise glazing or glazier points (not shown) which may be pushed into place on the inner surface 15 of the frame 14.

It should be noted that the cover 18 may be made out of glass, plastic, or any other suitable translucent, transparent or nearly transparent material. Additionally, while the textual or graphical content 30 as shown in FIG. 3, for example, is “Home is Where the Heart is”, any other saying (such as, but not limited to: “Home Sweet Home”, “Welcome”, “Gone Fishin'”, “Let it snow, let it snow”, etc.) or graphical content may be used in this disclosed system 10.

FIG. 2 shows a rear view of the frame 14. The frame 14 has four inner surfaces 15 (only two inner surfaces 15 are visible in this view), with at least one bendable tab 42 located on each of the inner surfaces 15. A lip 46 extends generally orthogonally from the inner surfaces 15. The lip 46, along with the plurality of bendable tabs 42, is configured to hold the base card 34, insert card 26, border 22, and cover 18 with the frame 14.

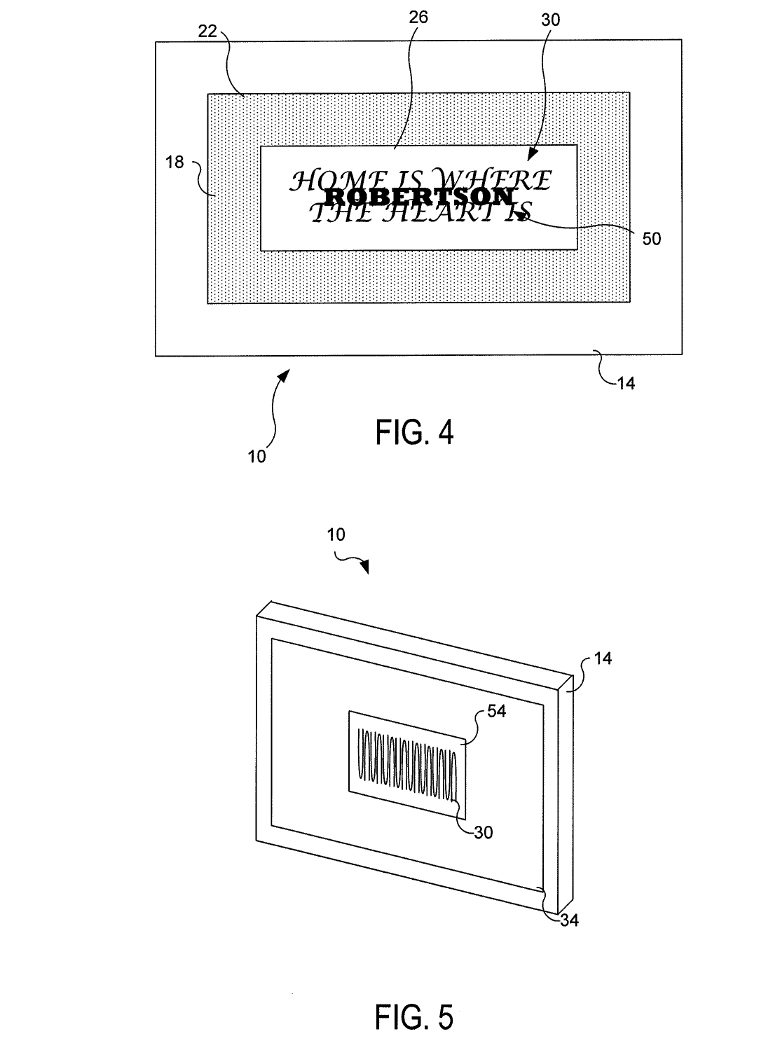

FIG. 3 shows a front view of the personalizable framed art system 10 in an embodiment as might be sold in a retail location or online. FIG. 4 shows a front view of the personalizable framed art system 10 after the insert card 26 has been personalized with a word or words 50. In this example, the word is a last name: Robertson. Of course in other embodiments, the word 50 may comprise a plurality of words, such as a first name and a last name, or other words, such as the name of a city, state, country, favorite sports team or athlete.

FIG. 5 shows a rear perspective view of the disclosed personalizable framed art system 10. In this view the rear of the frame 14 is shown. Attached to the rear of the frame may be a sticker 54 with information such as a website address and instructions to go to the website so that a consumer can personalize his or her insert card (e.g., “Go to www.websitename.com to personalize your artwork.”). In other embodiments, instead of a sticker, a sheet of instructions may be included in the packaging of the personalizable framed art system 10, that directs a consumer to a website so that the consumer can personalize his or her insert card. One website name that may be used is: www.namegameframe.com.

For a fee, the consumer can order a new insert card that has his/her name (or any other information that the consumer may desire) printed as a background behind the saying “Home is where the Heart Is” 30. In this case, the name “Robertson” 50 appears in a faint color or shaded font behind the saying “Home is where the Heart Is” (see, e.g., FIG. 4). The consumer can “preview” what the insert card will look like on the website, with his/her name (or any other desired information) behind the saying. Of course the consumer can order any name or word to be put behind the saying. In addition, the consumer can order different sayings for the insert card, e.g., “Home Sweet Home”, “Welcome”, etc. Also, the consumer can order different borders of art, in one embodiment, the consumer can order four (4) different borders to correspond to each of the seasons (winter, spring, summer, fall), or in another embodiment, the consumer can order borders corresponding to various holidays (Halloween, Christmas, Easter, July 4th, etc.). Or the consumer can buy packages of changeable borders to reflect a theme, golf, skiing or baseball/football for winter/spring sport. A series of “Though the Years” borders 22 may be sold though the website. The “Though the Years” series of borders can have a series of age appropriate borders for the toddler, pre-teen, teen, high school, or college-age child. These “Though the Years” borders may be gender specific as well as age specific. One disclosed personalizable framed art system 10 can be changed and updated with a child though 18 years (or more) of a child's life.

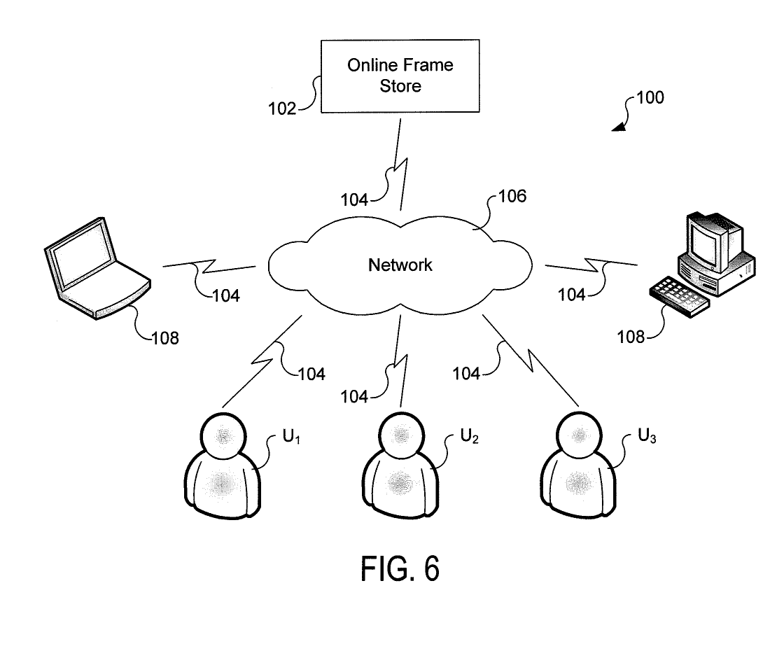

One suitable personalizable framed art system 100 according to another embodiment of the present invention is shown in FIG. 6. Such system 100 generally comprises an online frame store 102, which is coupled by suitable means 104 through a network 106 to a plurality of users U₁, U₂, U₃, each of whom may be using a computer or other digital device 108, in a standalone environment or on the network 106.

Moreover, network 106 may comprise a number of computers and associated devices that may be connected by communication facilities. It may also involve permanent connections such as cables or temporary connections such as those made through telephone or other communication links. Thus, network 106 may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network according to embodiments of the present invention may include: the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

As shown in FIG. 6, online frame store 102 may comprise a plurality of servers (not shown) coupled or connected to an Ethernet-based LAN. It may run, for example, on a simple server, or on a database server. More complex embodiments of the personalizable framed art system 100 may further comprise a certificate server, web server, and public/private key server.

In the embodiment shown in FIG. 6, the network may comprise a wireless network (e.g., comprising a plurality of wireless access points or WAP), which allows wireless communication devices to connect to the wireless network using Wi-Fi, Bluetooth or related standards. Each WAP usually connects to a wired network, and can relay data between the wireless devices (such as computers or printers) and wired devices on the network.

The wireless network may also comprise a wireless mesh network or WMN, which is a communications network made up of radio nodes organized in a mesh topology. Wireless mesh networks often consist of mesh clients, mesh routers, and gateways (not shown). The mesh clients are often laptops, cell phones and other wireless devices, while the mesh routers forward traffic to and from the gateways which connect to the Internet. The coverage area of the radio nodes working as a single network is sometimes called a mesh cloud. Access to this mesh cloud is dependent on the radio nodes working in harmony with each other to create a radio network. A mesh network is reliable and offers redundancy. When one node can no longer operate, the rest of the nodes can still communicate with each other, directly or through one or more intermediate nodes. Wireless mesh networks can be implemented with various wireless technology including 802.11, 802.16, cellular technologies or combinations of more than one type.

A wireless mesh network can be seen as a special type of wireless ad hoc network. It is often assumed that all nodes in a wireless mesh network are static and do not experience mobility however this is not always the case. The mesh routers themselves may be static or have limited mobility. Often the mesh routers are not limited in terms of resources compared to other nodes in the network and thus can be exploited to perform more resource intensive functions. In this way, the wireless mesh network differs from an ad hoc network since all of these nodes are often constrained by resources.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for caring out this disclosure.

What is claimed is:

1. A personalizable framed art system, comprising:
a frame;
a cover for protecting the art;
a border;
an insert card with content; and
a base card having means within which the insert card is adapted to be placed;
wherein the content is adapted to be personalized by a user of the personalizable framed art system.

2. The system according to claim 1, wherein the cover is translucent.

3. The system according to claim 1, wherein the cover is substantially transparent.

4. The system according to claim 1, wherein the cover is transparent.

5. The system according to claim 1, wherein the content comprises text.

6. The system according to claim 1, wherein the content comprises graphics.

7. The system according to claim 1, wherein the means within which the insert card is adapted to be placed in the base card comprises an indentation.

8. The system according to claim 1, wherein the means within which the insert card is adapted to be placed in the base card comprises a plurality of scores adapted to show where the insert card should lay.

9. The system according to claim 1, further comprising a removable pressure-sensitive acrylic adhesive adapted to attach the insert card to the indentation.

10. The system according to claim 1, further comprising a permanent adhesive adapted to attach the insert card to the indentation.

11. The system according to claim 1, further comprising a decorative design on the front surface of the border.

12. A personalizable framed art system, comprising:
an online frame store, which is coupled by suitable means through a network to a plurality of users U₁, U₂, U₃, each of whom may be using a computer or other digital device to construct a personalized frame comprising:
a frame;
a cover for protecting the art;
a border;
an insert card with content; and
a base card having means within which the insert card is adapted to be placed;
wherein the content is adapted to be personalized by a user of the personalizable framed art system.

13. The system according to claim 12, wherein the network comprises a number of computers and associated devices that may be connected by communication facilities.

14. The system according to claim 12, wherein the network comprises:
hard-wired connections selected from the group consisting of coaxial cable, twisted pair, optical fiber, and waveguides; and
wireless connections selected from the group consisting of radio frequency waveforms, free-space optical waveforms, and acoustic waveforms.
